(19) United States
(12) Patent Application Publication
(10) Pub. No.: US 2019/0394539 A1
(43) Pub. Date: Dec. 26, 2019

(54) SYSTEMS AND METHODS FOR PROXIMAL MULTIMEDIA EVENT SYNCHRONIZATION

(71) Applicant: AT&T Intellectual Property I, L.P., Atlanta, GA (US)

(72) Inventors: Eric Zavesky, Austin, TX (US); David Crawford Gibbon, Lincroft, NJ (US); James Pratt, Round Rock, TX (US); Behzad Shahraray, Holmdel, NJ (US); Zhu Liu, Marlboro, NJ (US)

(21) Appl. No.: 16/015,615

(22) Filed: Jun. 22, 2018

(51) Int. Cl. H04N 21/8547; H04N 21/43; H04N 21/442; H04N 21/4147

(52) U.S. Cl. CPC H04N 21/8547; H04N 21/4147; H04N 21/442; H04N 21/4302

(57) ABSTRACT

A system and method of synchronizing displays of a multimedia content stream in a plurality of devices are presented. A first multimedia stream of a content from a first content provider is provided to a first device. A second multimedia stream of the content from a second content provider is provided to a second device. A time stamp is generated for the first multimedia stream and the second multimedia stream. A synchronization offset is determined from a time on a global clock and the first time stamp and second time stamp. The first device is instructed to synchronize the first multimedia stream with the second multimedia stream. Feedback on the level of synchronization is received from the first device.

### TECHNICAL FIELD

This disclosure relates generally to audiovisual content delivery and in particular to synchronization of audiovisual content delivery to multiple devices.

### BACKGROUND

Different media playback, streaming technologies and licensing types cause differences in the timing of content presentation. This can cause problems with the colocation of different mobile or immobile content players which may be out of synchronization for highly critically timed content. For example, two users with different service providers may receive content at different times. This results in the display of the content not being synchronized. The consequence of the lack of synchronization is that one user will receive the content before the other user. In the case of a televised baseball game, the first user may be cheering a homerun while the second user is watching the batter in the batter's box preparing to take a swing at the pitch. This may spoil the experience of the second user who will be wondering what the first user was cheering about. There are also situations where the same program is being presented in two or more devices, such as for example a sports bar. In that case there may be a lack of synchronization resulting from the use of different devices causing an annoying echo effect.

There is a need to coordinate the timing of content presentation so that experiences for one party do not impact the experience of another party. This need is increasingly important as we develop distributed viewing experiences where one party is on another part of the world (possibly with another service provider) but they are seeking to share the same concurrent experience.

### SUMMARY

One general aspect includes a method including: providing a first device with a first multimedia stream and a second device with a second multimedia stream, generating a first time stamp for the first multimedia stream, generating a second time stamp for the second multimedia stream, determining a synchronization offset from a time on a global clock and the first time stamp and second time stamp, sending instructions to the first device to synchronize the first multimedia stream with the second multimedia stream, and receiving feedback from the first device about whether the first multimedia stream has been synchronized with the second multimedia stream. Other embodiments of this aspect include corresponding computer systems, apparatus, and computer programs recorded on one or more computer storage devices, each configured to perform the actions of the methods.

Implementations may include one or more of the following features. The method where sending instructions to the first device includes sending instructions to slow down the first multimedia stream until the first multimedia stream and the second multimedia stream are synchronized. The method where sending instructions to the first device includes sending instructions to record the first multimedia stream and to play back the first multimedia stream after a pause that synchronizes the first multimedia stream with the second multimedia stream. The method further includes sending content to the first device to be displayed during the pause. The method further includes determining which of the first multimedia stream and the second multimedia stream is delayed. The method further includes receiving from the first device a delay measurement between the first multimedia stream and the second multimedia stream where the delay measurement is generated by a sensor in the first device.

One general aspect includes a method including: receiving a synchronization opt in signal from a first device displaying a content stream, receiving from the first device a content display lag time between a first display of the content stream on the first device and a second display of the content stream on a second device, instructing the first device to pause the first display of the content stream for a pause interval equal to the content display lag time, and receiving synchronization feedback from the first device. Other embodiments of this aspect include corresponding computer systems, apparatus, and computer programs recorded on one or more computer storage devices, each configured to perform the actions of the methods.

Implementations may include one or more of the following features. The method where the content display lag time is measured from a start time of the content stream. The method where the first device includes a device selected from a group including a television, a smart phone, a desktop computer, a tablet computer, a laptop computer, or a PDA. The method where the step of receiving a synchronization opt in signal includes receiving a synchronization opt in signal at a service in a content provider network. The method further includes displaying additional content during the pause interval. The method where the content display lag time is measured by a sensor in the first device. The method where the first device displays the content stream from a first content provider and the second device displays a content stream from a second content provider. The method where the content display lag time is measured by a sensor in first device and a sensor in the second device. The method where the sensor in the first device and the sensor in the second device are audio sensors.

One general aspect includes a system including: a feedback verification module adapted to receive requests for synchronization and confirmations that synchronization has been achieved, an audiovisual synchronization module that synchronizes a first display of a multimedia stream in a first device with a second display of the multimedia stream in a second device by recording the display in the second device and replaying the second display after a pause interval, and a time repurpose algorithm that provides content during the pause interval.

Implementations may include one or more of the following features. The system where the audiovisual synchronization module resides in a content provider network. The system where the audiovisual synchronization module resides in the second device. The system where the second device includes a digital video recorder. The system where a first content provider is a source of the multimedia stream of the first display, and a second content provider is a source of the multimedia stream of the second display.

### BRIEF DESCRIPTION OF THE DRAWINGS

Other features of the present invention will be more readily understood from the following detailed description of specific embodiments thereof when read in conjunction with the accompanying drawings.

FIG. 1 is a block diagram of an embodiment of a system to synchronize two or more multimedia streams.

FIG. 2 is a block diagram of an alternate embodiment of a system to synchronize two or more multimedia streams.

FIG. 3 is a flowchart illustrating an embodiment of a method for synchronizing two or more multimedia streams.

FIG. 4 is a block diagram of an alternate embodiment of the system to synchronize two or more multimedia streams.

FIG. 5 is a flowchart illustrating an alternate embodiment of a method for synchronizing two or more multimedia streams.

FIG. 6 is a flowchart illustrating an alternate embodiment of a method for synchronizing two or more multimedia streams.

FIG. 7 is a flowchart illustrating an alternate embodiment of a method for synchronizing two or more multimedia streams.

FIG. 8 is a flowchart illustrating an alternate embodiment of a method for synchronizing two or more multimedia streams.

FIG. 9 is a flowchart illustrating an alternate embodiment of a method for synchronizing two or more multimedia streams.

### DETAILED DESCRIPTION OF ILLUSTRATIVE EMBODIMENTS

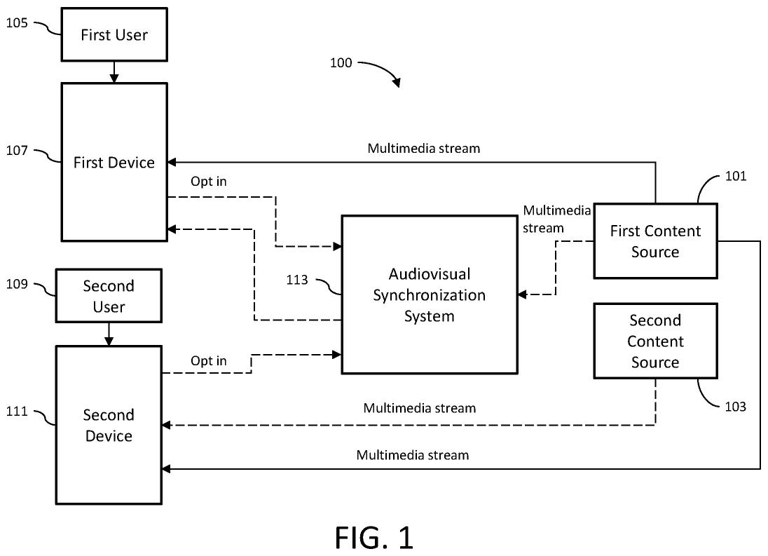

Illustrated in FIG. 1 is an embodiment of a framework 100 for synchronizing the display of content such as a multimedia stream. In one example the multimedia stream may be provided from first content source 101 and second content source 103. The multimedia stream of the first content source 101 is received by a first user 105 through the first device 107. The multimedia stream of the second content source 103 is received by a second user 109 through the second device 111. Although the content from the first content source 101 is the same as the content from the second content source 103, there may be a lack of synchronization of the displays due to the different content sources. In another example the multimedia stream is provided directly from first content source 101 to first device 107 and second device 111. In this example there may still be a lack of synchronization because of the difference in the first device 107 and second device 111. First device 107 and second device 111 may be a smart television, a smartphone, a desktop computer, a tablet computer, a laptop computer, a PDA, or the like.

In one embodiment, in order to synchronize the display of the multimedia streams, the multimedia stream from the first content source 101 is transmitted to an audiovisual synchronization system 113. The audiovisual synchronization system 113 synchronizes the display of the multimedia stream received by first device 107 and second device 111.

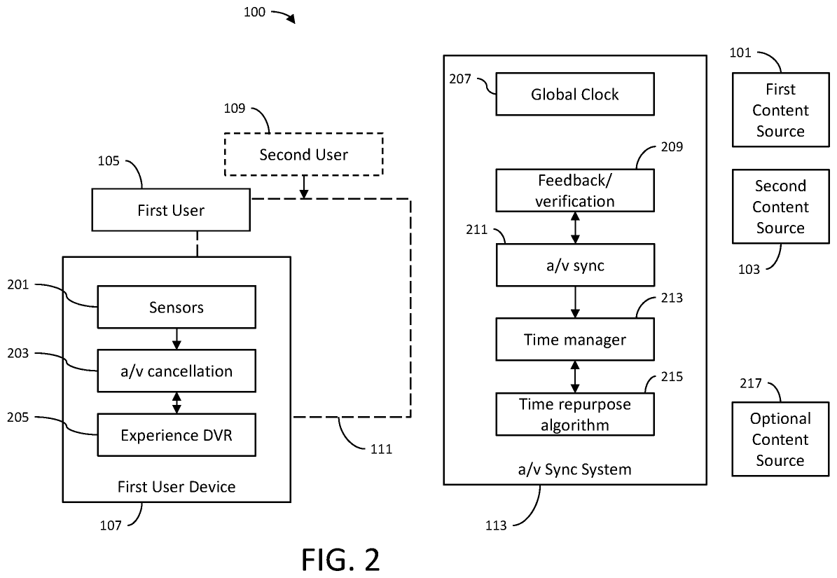

FIG. 2 illustrates the first user device 107 and the audiovisual synchronization system 113 in more detail. The first user device 107 may include sensors 201, an audiovisual cancellation module 203 and a memory buffer, storage device or data store to temporarily store the multimedia stream. One such device may be an experience digital video recorder (DVR) 205. DVR 205 provides the ability to record video in a digital format to a disk drive, USB flash drive, SD memory card, SSD or other local or networked mass storage device. The audiovisual synchronization system 113 may include a global clock 207, which may be used to place a timestamp on the content stream from the first content source 101 and a timestamp on the content stream from the second content source 103. The audiovisual synchronization module system 113 may include a feedback verification module 209 that communicates with the user devices and an audiovisual synchronization module 211. The audiovisual synchronization module 211 is where the computation of the delay between the two displays is performed. The audiovisual synchronization system 113 is also provided with a time manager module 213 and a time repurpose algorithm 215. The time management module 213 receives the time delay input from the audiovisual synchronization module 211 and communicates with first user device 107 to adjust the time delay for the streaming content. The time repurpose algorithm determines the extent of the delay and may provide additional content from optional content source 217 to fill in the time delay. The additional content may be advertising.

The audiovisual synchronization system 113 may be disposed at a content provider network. Alternately, the audiovisual synchronization system may be disposed locally on the users audiovisual system, or it could be disposed in the user device.

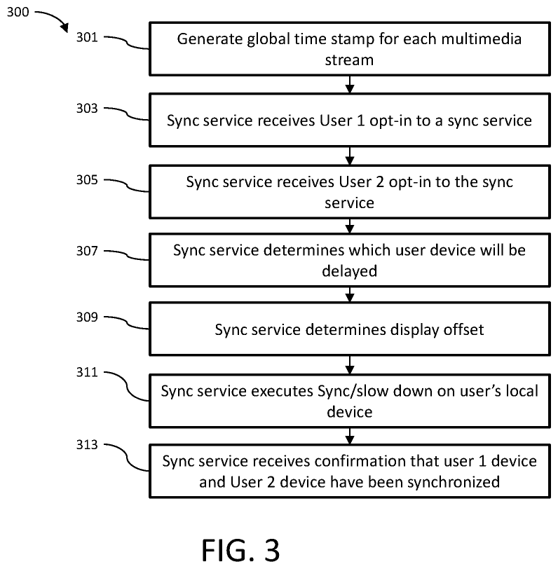

Illustrated in FIG. 3 is an embodiment of a method 300 that may be implemented by the systems described above. The method 300 may be used to synchronize the display of n devices.

In step 301, the method generates a time stamp for each of a plurality of multimedia streams. The time stamp may be relative to a global clock such as an atomic clock.

In step 303, a synchronization service, implemented by audiovisual synchronization system 113, receives a synchronization opt in request from a first device.

In step 305, the synchronization service may receive a synchronization opt in request from a second device or up to m devices, where m<n.

In step 307, the synchronization service determines which devices will be delayed. The devices to be delayed are the devices that have the shortest interval of time in displaying the content relative to the time stamp.

In step 309, the synchronization service determines a display offset to be provided to each device to be delayed.

In step 311, the synchronization service executes the synchronization on the device to be delayed. Synchronization may be achieved by slowing down the display of the content, or pausing the display, recording the content and playing back the content after a pause equivalent to the offset.

In step 313, the synchronization service may receive confirmation that the devices to be delayed have been delayed an appropriate amount of time to achieve synchronization. If the devices are not fully synchronized then the process may be repeated until synchronization is achieved.

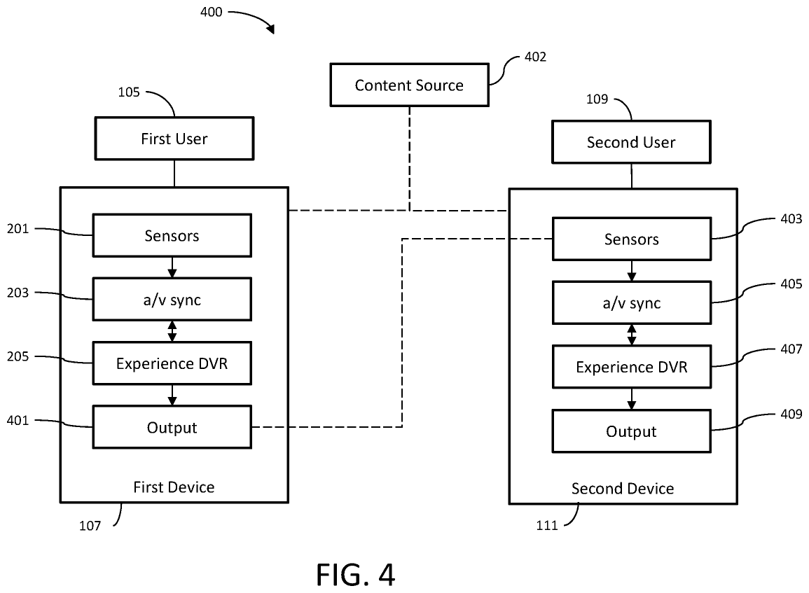

Illustrated in FIG. 4 is a peer-to-peer system of an alternate embodiment. In this embodiment the first user 105 operates the first device 107 having sensors 201, and audiovisual synchronization module 203, an experience DVR 205 and output module 401 that displays the content from the content source 402. The second user 109 operates a second device 111, having sensors 403, and audiovisual synchronization module 405, an experience DVR 407 and output module 409 that displays the content from the content source 402. The display of the content from output module 401 and output module 409 may not be synchronized because of differences in first device 107 and second device 111. In this embodiment, sensors 403 may detect output display signals from output module 401 and may determine that there is a lag between the display signals from output module 401 and output module 409 (i.e. the display signals from output module 409 lag the display signals from output module 401. Sensors 403 may include video sensors that detect the difference in lag time between the video display from output module 409 and output module 401. Alternately, sensors 403 may include audio sensors to detect the difference in lag time between the sounds from output module 409 and output module 401. Audiovisual synchronization module 405 may calculate the offset necessary to synchronize the output of the signals from the first device 107 and the second device 111. Experience DVR 407 may be used record the content from the content source to delay the display of the output module 409 by the offset necessary to synchronize the output of signals.

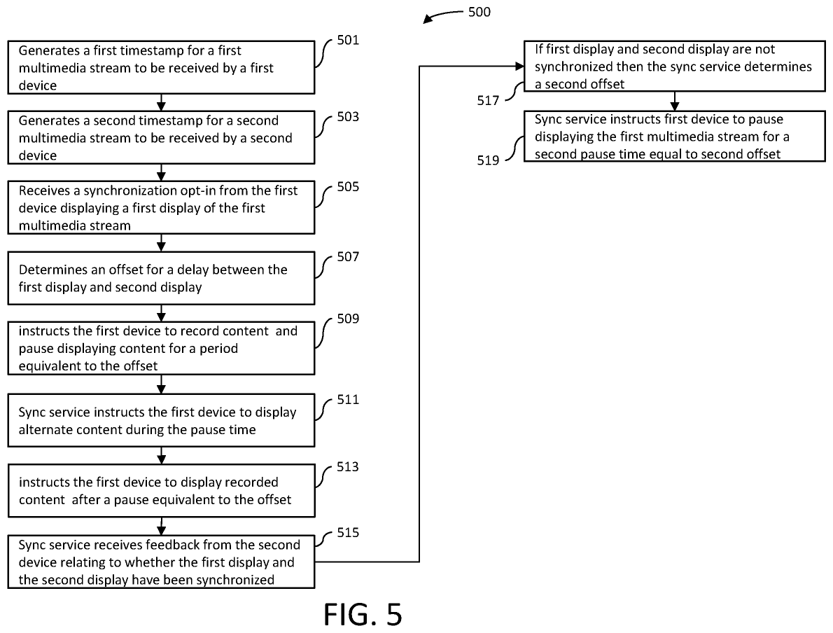

Illustrated in FIG. 5 is an embodiment of a method 500 that may be implemented by the synchronization service of an audiovisual synchronization system 113.

In step 501, a synchronization service generates a first timestamp for a first multimedia stream to be received by a first device.

In step 503, the synchronization service generates a second timestamp for a second multimedia stream to be received by a second device. The first multimedia stream and the second multimedia stream are associated with the same content, and may be provided by different content providers.

In step 505, the synchronization service receives a synchronization opt-in from the first device displaying a first display of the first multimedia stream. The second display is displayed with a delay relative to the first display and in this case the user of the first device wants to slow down or pause the first display to synchronize it to the second display.

In step 507, the synchronization service determines a synchronization offset based on the delay.

In step 509, the synchronization service instructs the first device to record the multimedia stream and pause displaying the first multimedia stream for a pause time equivalent to the first synchronization offset.

In step 511, the synchronization service instructs the first device to display alternate or additional content during the pause time. The additional content may inserted while the program (original content) is in a commercial break. Alternately, the advertising being displayed in a commercial break may be sped up or slowed down in order to effect the synchronization between the display of content by first device 107 and second device 111. In yet another approach the display of the original content may be recorded and replayed at a slower speed until the synchronization is achieved.

In step 513, the synchronization service instructs the first device to display the recorded content after a pause equivalent to the offset.

In step 515, the synchronization service receives feedback from the second device relating to whether the first display and the second display have been synchronized.

In step 517, if the first display and the second display have not been synchronized then the synchronization service may determine a second synchronization offset.

In step 519, the synchronization service may instruct the first device to pause displaying the first multimedia stream for a second pause time equivalent to the second synchronization offset.

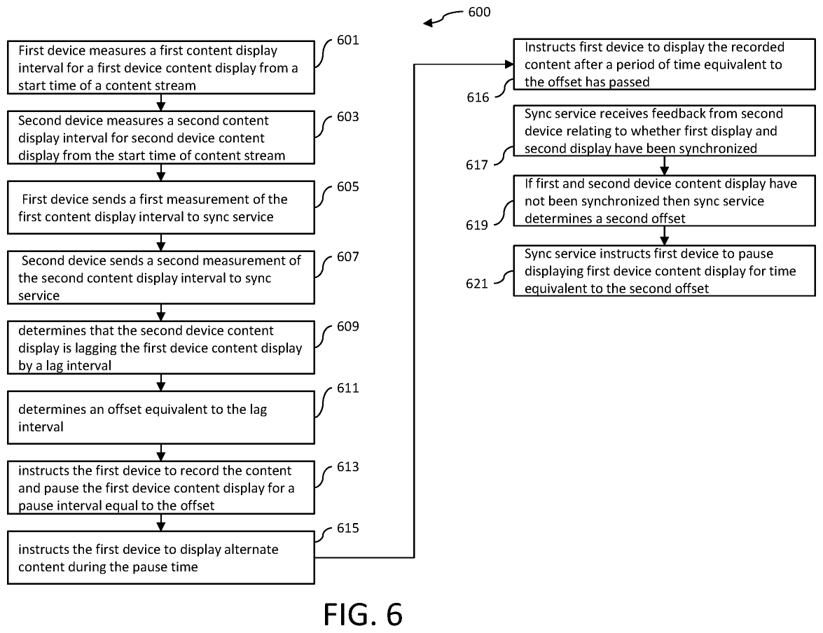

Illustrated in FIG. 6 is a flowchart for an alternate embodiment of a method 600 that may be implemented by the systems described above.

In step 601, a first device measures a first content display interval for a first device content display from a start time of a content stream.

In step 603, a second device measures a second content display interval for a second device content display from the start time of the content stream wherein the second content display interval is longer that the first content display interval.

In step 605, the first device sends a first measurement of the first content display interval to the synchronization service.

In step 607, the second device sends a second measurement of the second content display interval to the synchronization service.

In step 609, the synchronization service determines that the second device content display is lagging the first device content display by a lag interval.

In step 611, the synchronization service determines an offset equivalent to the lag interval.

In step 613, the synchronization service instructs the first device to record the content and pause the first device content display for a pause interval equal to the offset.

In step 615, the synchronization service instructs the first device to display alternate or additional content during the pause time. The additional content may be inserted while the program (original content) is in a commercial break. Alternately the advertising being displayed in a commercial break may be sped up or slowed down in order to effect the time offset between the display of content by first device 107 and second device 111.

In step 616 the synchronization service instructs the first device to display the recorded content after a period of time equivalent to the offset has passed.

In step 617, the synchronization service receives feedback from the second device relating to whether the first display and the second display have been synchronized.

In step 619, if the first device content display and the second device content display have not been synchronized, then the synchronization service may determine a second synchronization offset.

In step 621, the synchronization service may instruct the first device to pause displaying the first device content display for a second pause time equivalent to the second synchronization offset.

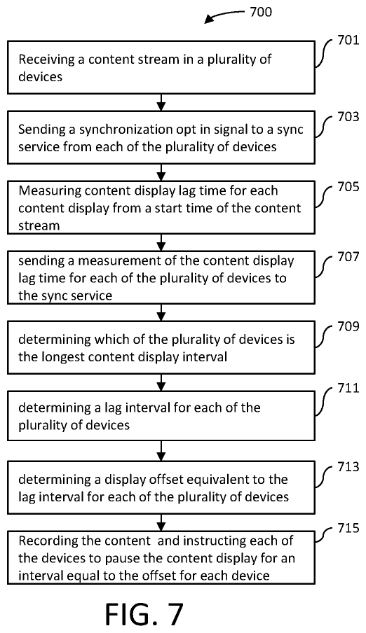

Illustrated in FIG. 7 is a flowchart for an alternate embodiment of a method that may be implemented by the systems described above.

In step 701, a content stream is received in a plurality of devices.

In step 703, an opt in signal is sent to a synchronization service from a subset of the plurality of devices.

In step 705, a content display lag time for each content display is measured from the start time of the content stream at each of the devices in the subset. So for example, if a program starts at 8 PM and the display of the program in device (1) starts at 8:00:05 the lag time would be 05 seconds. If the display of the program in device (2) starts at 8:00:07 the lag time would be 07 seconds.

In step 707, a measurement of the content display lag time for each of the devices in the subset is sent to the synchronization service.

In step 709, the device in the subset with the longest content display lag time is determined. In the example above the device with the longest content display lag time would be device (2), with a lag time of 07 seconds.

In step 711, a lag interval for each of the plurality of devices may be determined relative to the longest content display interval. In other words, to synchronize device (1) with device (2) the lag interval would be the lag time of device (2) minus the lag time of device (1).

In step 713, a display offset equivalent to the lag interval for each of the plurality of devices is determined. For example, device (1) may have a content display lag interval of t₁, device (2) may have a content display lag interval of t₂ and device (n) may have a content display lag interval of tₙ. In this example, t₁<t₂<tₙ, so tₙ is the longest lag time. Device (1), device (2) and device (n−1) may desire to synchronize their display to the display of device (n). So the offset for device (1) would be tₙ-t₁, the offset for device 2 would be tₙ-t₂ and the offset for device (n−1) would be tₙ−₍ₙ₋₁₎.

In step 715, each of the plurality of devices is instructed to record the content and pause the content display for a pause interval equivalent to the offset for each device.

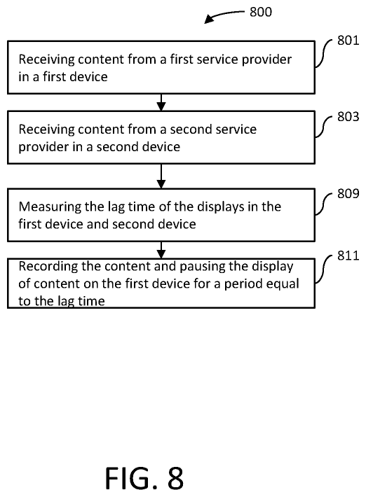

Illustrated in FIG. 8 is a flow chart of an alternate embodiment of a peer-to-peer method 800 for synchronizing signals from different service providers.

In step 801, content from a first service provider is displayed in a first device.

In step 803, content from a second service provider is displayed in a second device. In this example, the content display in the first device lags the content display in the second device, and the user of the second device desires to synchronize the content display of the second device to the content display of the first device.

In step 809, the second device measures the lag time between the display of the content from the first device and the display of the content from the second device. The measurement may be accomplished by analyzing the sound from the displays or the visual images of the display.

In step 811, the content received by the second device is recorded and display of the content on the second device is paused for a period of time equal to the lag time. Alternately, the display of the content on the second device may be slowed down until the display in both devices are synchronized.

As with the previous examples, additional content may be displayed during the pause, and feedback relating to the synchronization may be provided.

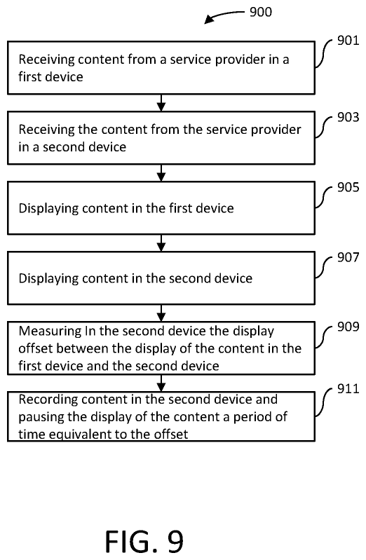

Illustrated in FIG. 9 is a flowchart for an embodiment of a method 900 that may be implemented by the systems described above. In this example, content is provided by a single content provider to two different devices.

In step 901, content from the service provider is received in a first device.

In step 903, the content from the service provider is received in a second device.

In step 905, content from the service provider is displayed in the first device.

In step 907, the content from the service provider is displayed in the second device.

In step 909, the offset between the display of the content in the first device and the content in the second device is measured. Measurement may be accomplished through sensors on the first device and/or second device. The sensors may measure the difference in the sounds of the display or differences in the visual displays.

In step 911, the second device records the content and pauses the display of the content for a period of time equivalent to the offset. After a period of time equivalent to the offset has passed the recorded content is displayed.

In one embodiment the synchronization service may be effected between two devices that are geographically separate (e.g. different cities) where the synchronization is accomplished using a video calling service such as FaceTime. In another embodiment the synchronization services may be provided by a video calling service.

In one embodiment a DVR may be applied to a neighbor audio in a non-cooperative fashion so that it can be played back at the user's synchronized time points.

In one embodiment a device may cancel non-synchronized sound or block non-synchronized video from another device. Noise cancellation is a method for reducing unwanted sound by the addition of a second sound specifically designed to cancel the first. Specifically, using audio sensors to capture and noise-cancel proximal audio (cheers), or using visual sensors to capture and replay reactions, and using network controls to capture and delay social content.

In one embodiment if the user is not home, the user's DVR/in-home system can record audio of neighbors to play back later. In one embodiment synchronization may be disengaged if the two users are too far away (including location and connections between users) or not in shared experience.

In one embodiment continual feedback and interaction between two devices would maintain content stream synchronization (e.g. a network-based synchronization manager).

In yet another embodiment, a sensor configuration could be placed in stadiums to capture and record the audio of the crowd and visuals (sky writing or the scoreboard) that could be replayed in various forms (mobile devices with spatial audio, home theaters with 10.4 surround sound, etc.).

The audiovisual synchronization system 113 may be used with social media to delay social media so that a user can avoid revealing an important detail of plot development in a program or an important development in an event (such as scoring of runs in a baseball game). The audiovisual synchronization system 113 may coordinate with a social network platform such as Facebook or Twitter to suppress messages to an account with the same knowledge of the offset. Thus, for example a user in the West Coast may opt in to delay delivery of any messages regarding a specific program until that program has been broadcasted in the West Coast.

The methods and systems disclosed herein enable the user to (1) avoid interruptions of events from neighbors and other proximal content watchers of the same stream, but with different sync and buffer delays (2) synchronize co-watching between remote parties (mobile or otherwise) with high precision and automatically instead of burdening the user (3) allowing time delay of crowd and external noises so they can be experienced in parallel with your event; even accommodating a DVR aspect of watching a previously live event (4) Intelligently manipulate supplementary content (e.g. advertisements) to accommodate a delay between viewers in different locations instead of negative or empty playback (5) engage in additional coordination measures such as social media coordination.

The benefits of the methods and systems disclosed herein include: (1) improvement of the content viewing experience (customer satisfaction) because the salient events are not pre-disclosed by neighbors or other viewers; (2) better interaction among viewers, especially in the co-watching scenario, since all viewers are watching the synchronized content; (3) Providing more opportunities for targeted advertisements (revenue growth), since they can be used to fill in the gaps for the clients that receive content earlier than others; (4) using feedback to improve the content distribution infrastructure to minimize the delay in content delivery; and (5) Allowing for multiple cameras at a live venue to be delivered independently and assembled at the viewer's display (or displays).

Embodiments of the present disclosure can be implemented in hardware, software, firmware, or a combination thereof. In various embodiment(s), system components are implemented in software or firmware that is stored in a memory and that is executed by a suitable instruction execution system. If implemented in hardware, as in some embodiments, system components can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Software components may comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the present disclosure includes embodying the functionality of one or more embodiments in logic embodied in hardware or software-configured mediums.

Conditional language, such as, among others, “can,” “could,” “might,” or “may,” unless specifically stated otherwise, or otherwise understood within the context as used, is generally intended to convey that certain embodiments could include, but do not require, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present disclosure.

What is claimed:

1. A method comprising:
providing a first device having a data store with a first multimedia stream of a content from a first content provider
providing a second device with a second multimedia stream of the content from a second content provider wherein the second multimedia stream is delayed relative to the first multimedia stream;
generating a first time stamp for the first multimedia stream;
generating a second time stamp for the second multimedia stream;
determining a synchronization offset from a time on a global clock and the first time stamp and second time stamp;
sending instructions to the first device to synchronize the first multimedia stream with the second multimedia stream;
recording the first multimedia stream in the data store; and
receiving feedback from the first device about whether the first multimedia stream has been synchronized with the second multimedia stream.

2. The method of claim 1 wherein sending instructions to the first device comprises sending instructions to the first device to record the first multimedia stream in the data store and to begin playing the first multimedia stream recorded in the data store after a period of time equivalent to the synchronization offset has elapsed.

3. The method of claim 1 wherein sending instructions to the first device comprises sending instructions to record the first multimedia stream and to play back the first multimedia stream recorded in the data store after a pause that synchronizes the first multimedia stream with the second multimedia stream.

4. The method of claim 3 further comprising sending content to the first device wherein the content is displayed during the pause.

5. The method of claim 1 further comprising determining which of the first multimedia stream and the second multimedia stream is delayed.

6. The method of claim 1 further comprising receiving from the first device a delay measurement between the first multimedia stream and the second multimedia stream wherein the delay measurement is generated by a sensor in the first device.

7. A method comprising:
receiving a synchronization opt in signal from a first device displaying a content stream;
receiving from the first device a content display lag time between a first display of the content stream on the first device and a second display of the content stream on a second device;
instructing the first device to record the content stream;
displaying the content stream recorded by the first device after a pause interval equal to the content display lag time; and
receiving synchronization feedback from the first device.

8. The method of claim 7 wherein the content display lag time is measured from a start time of the content stream.

9. The method of claim 7 wherein the first device comprises a device selected from a group comprising a television, a smart phone, a desktop computer, a tablet computer, a laptop computer, or a PDA.

10. The method of claim 7 wherein the step of receiving a synchronization opt in signal comprises receiving a synchronization opt in signal at a service in a content provider network.

11. The method of claim 7 further comprising displaying additional content during the pause interval.

12. The method of claim 7 wherein the content display lag time is measured by a sensor in the first device.

13. The method of claim 7 wherein the first device displays the content stream from a first content provider and the second device displays a content stream from a second content provider.

14. The method of claim 13 wherein the content display lag time is measured by a sensor in the first device and a sensor in the second device.

15. The method of claim 14 wherein the sensor in the first device and the sensor in the second device is an audio sensor.

16. A system comprising:
a feedback verification module adapted to receive requests for synchronization and confirmations that synchronization has been achieved;
an audiovisual synchronization module that synchronizes a first display of a multimedia stream in a first device with a second display of the multimedia stream in a second device by instructing recording of the multimedia stream in the second device and replaying the multimedia stream in the second device after a pause interval; and
a time repurpose algorithm that provides content during the pause interval.

17. The system of claim 16 wherein the audiovisual synchronization module resides in a content provider network.

18. The system of claim 16 wherein the audiovisual synchronization module resides in the second device.

19. The system of claim 16 wherein the second device comprises a digital video recorder.

20. The system of claim 16 wherein a first content provider is a source of the multimedia stream of the first display, and a second content provider is a source of the multimedia stream of the second display.
